(19) United States
(12) Patent Application Publication
(10) Pub. No.: US 2006/0085128 A1
(43) Pub. Date: Apr. 20, 2006

(54) User-friendly directional device

(76) Inventors: V. Gerald Grafe, Corrales, NM (US); Elise N. Grafe, Corrales, NM (US); Zachary D. Grafe, Corrales, NM (US)

Correspondence Address: V. Gerald Grafe, esq., P.O. Box 2689, Corrales, NM, 87048, US

(21) Appl. No.: 11/252,125

(22) Filed: Oct. 15, 2005

Related U.S. Application Data
(60) Provisional application No. 60/619,592, filed on Oct. 15, 2004.

(51) Int. Cl. G01C 21/28

(52) U.S. Cl. 701/213; 342/357.08

(57) ABSTRACT

The present invention provides a user experience greatly simplified from prior art GPS devices. The invention provides for storage of one or more locations, by simple user interactions tailored to the specific interaction environment. The invention also provides for determination of the current location of the user. The invention compares the current location to a selected stored location to determine a direction from the present location to the stored location. The invention also provides a determination of the present orientation of a display, relative to, as an example, magnetic north. The present orientation of the display can be combined with the determined direction to determine a configuration of the display that indicates a direction of travel toward the stored location. The invention can comprise a vehicle security system controller, and the operation of the invention integrated with the operation of the locking/unlocking of the vehicle.

### RELATED APPLICATIONS

This application claims priority to U.S. provisional application 60/619,592, “User-friendly Directional Device,” filed Oct. 15, 2004, incorporated herein by reference.

### BACKGROUND

The present invention relates to the field of directional devices, specifically devices that use the global positioning system.

The Global Positioning System (GPS) is a space-based radio-navigation system comprising a constellation of satellites and a network of ground stations used for monitoring and control. A minimum of 24 GPS satellites orbit the Earth at an altitude of approximately 11,000 miles providing users with accurate information on position, velocity, and time anywhere in the world and in all weather conditions.

GPS is operated and maintained by the U.S. Department of Defense (DoD).The Interagency GPS Executive Board (IGEB) manages GPS, while the U.S. Coast Guard acts as the civil interface to the public for GPS matters. The Federal Aviation Administration is investigating and applying the use of GPS as it pertains to aviation.

GPS, formally known as the Navstar Global Positioning System, was initiated in 1973 to reduce the proliferation of navigation aids. By creating a system that overcame the limitations of many existing navigation systems, GPS became attractive to a broad spectrum of users worldwide. GPS has been successful in virtually all navigation applications, and because its capabilities are accessible using small, inexpensive equipment, GPS is being utilized in a wide variety of applications across the globe.

Current GPS devices are complex. They generally require significant knowledge of maps and navigation. Some stores catering to hikers offer 4 hour classes in “how to use a GPS,” illustrating the complexity of current devices.

All of the current applications of GPS technology require either extensive knowledge of mapping and navigation, or expensive large screen displays integrated with complex user interfaces. There is a need to applications of the technology that make the benefits available to people without specialized navigation expertise and without undue expense and size.

### SUMMARY OF THE INVENTION

The present invention provides a user experience greatly simplified from prior art GPS devices. The invention provides for storage of one or more locations, by simple user interactions tailored to the specific interaction environment. The invention also provides for determination of the current location of the user. The invention compares the current location to a selected stored location to determine a direction from the present location to the stored location. The invention also provides a determination of the present orientation of a display, relative to, as an example, magnetic north. The present orientation of the display can be combined with the determined direction to determine a configuration of the display that indicates a direction of travel toward the stored location. The invention can comprise a vehicle security system controller, and the operation of the invention integrated with the operation of the locking/unlocking of the vehicle.

### DRAWINGS

FIG. 1 is a functional block diagram of an apparatus 100 according to the present invention.

FIG. 2 is a schematic representation of the results of the functions of an example apparatus according to the present invention.

FIG. 3 is an illustration of an embodiment of the present invention used as an aid to returning to a previous location.

FIG. 4 is an illustration of an embodiment of the present invention used as an aid to returning to a previous location.

FIG. 5 is an illustration of an example embodiment of the present invention.

FIG. 6 is an illustration of an example embodiment of the present invention.

FIG. 7 is an illustration of an example embodiment of the present invention.

FIG. 8 is an illustration of an example embodiment of the present invention.

### DETAILED DESCRIPTION OF THE INVENTION

The present invention provides a user experience greatly simplified from prior art GPS devices. The invention provides for storage of one or more locations, by simple user interactions tailored to the specific interaction environment. The invention also provides for determination of the current location of the user. The invention compares the current location to a selected stored location to determine a direction from the present location to the stored location. The invention also provides a determination of the present orientation of a display, relative to, as an example, magnetic north. The present orientation of the display can be combined with the determined direction to determine a configuration of the display that indicates a direction of travel toward the stored location.

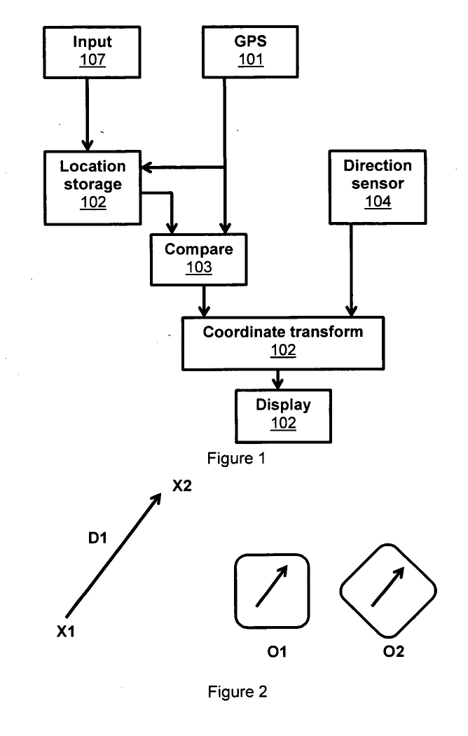

FIG. 1 is a functional block diagram of an apparatus 100 according to the present invention. The blocks shown are representative of functions only; the arrangement, configuration, and integration of the functional blocks can vary depending on details of the implementation. For example, several of the functions can be performed by a single microcontroller. Also, the functional blocks are controlled by a control system, not shown in the figure for clarity.

A GPS receiver 101 uses information from the GPS system to determine the present location of the receiver 101. That location can be stored in a location storage facility 102 at the direction of a user via a user input function 107. In some embodiments locations can be stored in the location storage facility by directly loading locations, without requiring that the apparatus be physically present at the location to be stored. That location can also be used as an input to a comparator 103. The other input to the comparator can be a location accessed from the location storage facility 102, which in some embodiments stores a single location, and in others can store a plurality of locations. In embodiments storing a plurality of locations, the stored location for input to the comparator can be selected based on input from a user 107. The comparator 103 can determine an absolute direction from the present location to the stored location.

A direction sensor 104 can determine the absolute orientation of a display 106. That orientation can then be combined 105 with the absolute direction to determine a direction relative to the display from the present location to the stored location. That direction can then be indicated on the display 106, providing the user with an indication of the direction to travel toward the stored location, without requiring any special navigation skills or maps. The direction sensor can be a static direction sensor, or a sensor that does not require motion of the device to determine the present orientation. A magnetic compass is a common example of a static direction sensor, and can be integrated with the GPS receiver in the present invention. Alternatively, the GPS sensor itself can be used to determine the most recent position history of the apparatus, providing an orientation based thereon. This non-static direction sensor can be less user-friendly in some applications, since the apparatus will not reflect changes in orientation of the apparatus if the user stops moving to turn and evaluate directions.

FIG. 2 is a schematic representation of the results of the functions described above. The apparatus in the figure is currently at location X1. The stored location is shown as X2. The absolute direction from X1 to X2 is shown as the arrow D1. Two representations O1, O2 are shown of the display. In both orientations O1, O2, the device display indicates a direction corresponding to the direction D1. The direction indicated changes relative to the display as the orientation of the display changes, but, since the orientation of the display is considered when determining the display, the display output to the user is always indicative of the correct direction of travel.

The implementation of the functionality described can be tailored to the specific application. GPS receivers are commonly available in the art, with various levels of performance, integration, and price. Microcontrollers suitable for implementing the control, user interface, display, and location manipulation are commonly available. A wide variety of displays can be suitable; price, performance, reliability, size, or other application constraints can guide the choice of display.

### EXAMPLE EMBODIMENT

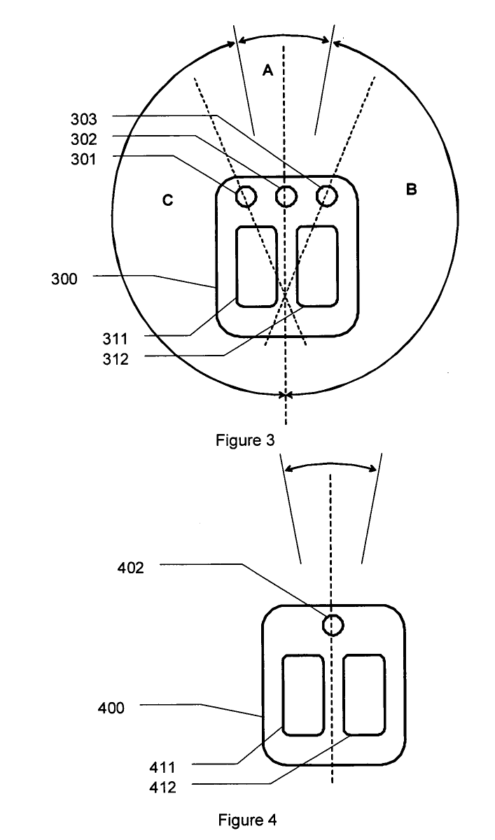

FIG. 3 is an illustration of an embodiment of the present invention used as an aid to returning to a previous location. A housing 300 comprises user input devices 311, 312 and display indicators 301, 302, 303. An example of such a device is an automobile keyless entry control device or alarm key fob. In such an example, one input device 311 can be used to lock the doors or set the alarm. One input device 312 can be used to unlock the doors of disable the alarm. The present embodiment can be integrated with such functions, and can be implemented as a standalone device.

The apparatus comprises a GPS receiver, location storage facility, comparator, and orientation determination as discussed before. In operation, a user input (such as pressing a button) causes the present location of the apparatus to be stored in the location storage facility. When integrated with an automobile keyless entry device, the button that locks the doors can be used as the signal to store the present location in the location storage facility. The user can then carry the apparatus as the user moves away from the stored location, for example on a hike or across a parking structure to an entertainment venue. When later the user desires to return to the stored location, for example to find the car after the hike or the entertainment program, the apparatus can indicate the direction to travel as discussed below. The apparatus can indicate the direction to travel continuously, or can indicate the direction in response to a user input (such as pressing a button). Indication responsive to an input can reduce the power requirements of the display. The “lock” button can be used to store the then-current location, such that no incremental action by the user is required to “remember” the location of the vehicle. The user can use the “unlock” button to request direction to the vehicle; for example when the unlock button is pressed, the device can indicate the direction to the car. To avoid premature unlocking, the apparatus can only send the unlock signal to the vehicle if the device is within a threshold distance from the vehicle. For example, pressing the unlock button when over one hundred yards from the vehicle might initiate only the GPS direction indication but no signal to the vehicle; pressing between 30 and one hundred yards might initiate the GSP direction indication and a “honk horn” or “flash lights” signal to the vehicle; pressing at less than 30 yards might initiate the GPS signal, the honk or flash signal, and an unlock signal.

The apparatus can determine the direction relative to the display as lying in one of three sections A, B, C A direction in section B indicates that the stored location is to the right of a line defined by the display; in the figure an axis of the apparatus is used as the defining line. A direction in section C indicates that the stored location is to the left of the line. A direction in section A indicates that the stored location is approximately in line with the line. The indicator corresponding to the direction can be highlighted; as an example, the indicators can be light emitting diodes (LEDs), energized to illuminate when the direction corresponds to the section to which the LED corresponds.

As an example, as the user decides to return to the stored location, for example to a car previously locked with an integrated apparatus according to the present invention, a red light can be generated by an LED 303, indicating that the car is to the right of the current direction pointed by the apparatus. The user can turn the apparatus to the right until the red light is extinguished and a green light generated by an LED 302, indicating that the car is ahead. The user can then travel in the direction indicated until the car is in visible range. If, as an example, the user passes the car with the car on the left, the green light will be extinguished and a red light generated by an LED 301, indicating that the user needs to travel to the left to find the car. Turning so that the green light is illuminated will return the user to a direct path to the car or other stored location.

The apparatus allows reliable return to the car or other stored location, even if there are obstacles (e.g., traffic patterns or walkways) that force temporary travel not in direct line to the car or other stored location, and even if such obstacles have changed since the original travel away from the car (e.g., different traffic patterns after an entertainment event, or exiting a venue from a different port, or traveling to multiple sites before desiring to return directly to the car or other stored location). It also allows a person with imperfect memory of the location of the car or other stored location to reliably find the car or other stored location, either a forgetful user or another person.

Alternative displays can also be used. As one example, a single line or arrow can be displayed, oriented directly along the determined direction to the car or other stored location, instead of separate indicators. The apparatus then serves like a traditional compass, except that instead of pointing north and requiring orienteering skills to navigate, the apparatus simply points the direction the user should go. As another example, a single indicator 402, like that shown in FIG. 4, can be used. The single indicator can be highlighted when the direction is within a range of the direction indicated by a defining line of the apparatus. It can be highlighted, for example, by being off when the direction is not in the range and on when the direction is in the range. It can also have a plurality of states, e.g., different colors or intensities, indicative of the degree of alignment between the determined direction and the defining line (e.g., red indicating more than 90 degrees off, yellow indicating more than 15 and less than 90 degrees off, and green indicating within 15 degrees).

### Example Embodiment

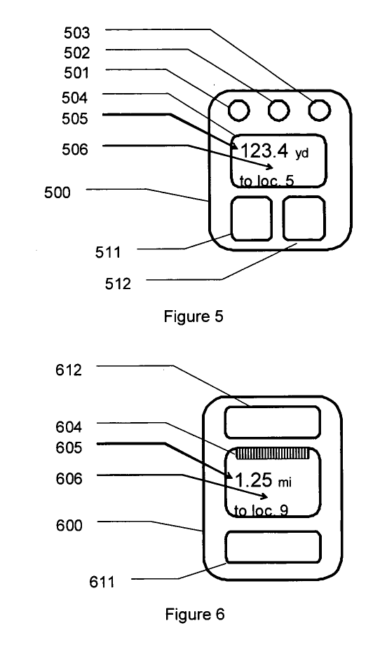

FIG. 5 is an illustration of another example embodiment of the present invention. A housing 500 provides mounting for two user inputs 511, 512, a display 506, and three direction indicators 501, 502, 503. A GPS receiver (not shown) can determine the present location of the apparatus. A user can indicate which of a plurality of stored locations is active by manipulation of the user inputs, for example by pressing a first button 511 to decrement an index into the plurality, and pressing a second button 512 to increment the index. The user can indicate that the present location of the apparatus is to be stored corresponding to the present index by manipulating the inputs, for example by pressing and holding both buttons simultaneously.

The display 506 can communicate the index of the currently active stored location in the plurality of stored locations (“to loc 5” in the figure). The display can also communicate the distance from the present location of the apparatus to the currently active stored location (“123.4 yd” in the figure). In this way, the user can know the distance to any of a plurality of stored locations; for example the distance to a car, to a stream crossing, and to a scenic viewpoint. The direction indicators 501, 502, 503 can be used in a similar manner as described for the previous example embodiment, with a first indicator 501 indicating that the direction to the currently active stored location is to the left of an axis line, a second indicator 502 indicating that the direction to the currently active stored location is substantially in line with an axis line, and a third indicator 503 indicating that the direction to the currently active stored location is to the right of the axis line. The user can thus easily find the direction and distance to any of the plurality of stored locations. A user can use the apparatus to remember the location of a start of a hike, then remember subsequent locations along the hike (e.g., forks in a trail, points of interest, obstacle crossings, etc.). Once stored in the apparatus, the apparatus allows the user to easily find the way back to a stored location, without requiring special navigation skills or specific order of travel. The display can be continuous, or can be selectively energized to conserve power, for example in battery-operated applications.

### Example Embodiment

FIG. 6 is an illustration of an example embodiment of the present invention. Its operation is similar to that discussed for the previous embodiment. The user inputs can comprise two buttons or touch-sensitive areas 611, 612. In the figure they are disposed above and below the display 606, making the increment and decrement operations more intuitive. The display 606 can display an identifier for the current active stored location, and the distance from the present apparatus location to the currently active stored location. The direction indicators of the previous example have been replaced with a single indicator 604, shown in the figure as a multiple segment bar indicator. The multiple segments can be selectively energized to indicate the direction from the current location to the currently active stored location, with a correspondence similar the three indicator examples described before but with higher resolution. Other direction indicators can also be suitable; for example an indicator like a compass needle, except pointing the desired direction rather than north, can be suitable. Multi-segment bar displays can also comprise various configurations; for example, a bar display can be configured in an arc to be more suggestive of the direction of travel. The direction indicators can also comprise a greater portion of the possible directions; for example, segments can be disposed around half or all of the circumference of the display, allowing high resolution communication of the direction.

### Example Embodiment

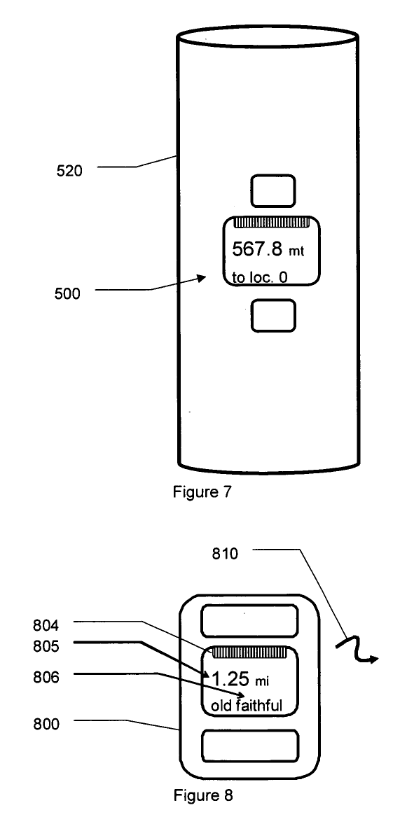

FIG. 7 is an illustration of an example embodiment of the present invention. The operation of the example shown is similar to that described in the previous examples. The user inputs can be mounted separately from the display 500, allowing accommodation of variations in shape of a host object 520. The host object can be, as an example, a walking staff, allowing a user to have easy-to-use navigation assistance anytime on a walk. As another example, the host object can be a flashlight, combining easy to use navigation with the portability and power source common in flashlights. As other examples, the host device can be a bike (frame or mounted as an accessory), a ski pole, a water bottle cap or holder, or a radio.

### Example Embodiment

FIG. 8 is an illustration of an example embodiment of the present invention. The direction and distance operation can be as described for the previous examples. The apparatus 800 has an interface 810 for communication with a host that has location information. The location information at the host can be, for example, text (or other information) and coordinates for significant landmarks, places to visit, or points along a defined trail. The host can load the location information into a location storage facility on the apparatus using the interface, which can be, as examples, a USB interface, a wireless computer interface such as 802.11g, or a Bluetooth interface. The locations loaded from the host can be marked so that the user can not overwrite them from the user inputs; the apparatus can optionally be allowed to load other, personal locations. The interface can also be used to load locations from the apparatus to a host. A user can thus store locations of interest, then, on return to the host, use those stored locations to find out more information about the location (e.g., the name of a specific geologic or historical feature, or to plot the location on a map). Suitable sets of stored locations can be used, as examples, as active maps for trails at parks, resorts, and monuments. The information stored with the locations can be simple text identifiers to display, and can comprise audio or video information to be played for the user when the user arrives within a certain distance of the location (e.g., an audio description of the location) or when the user arrives within a certain distance and directs the apparatus toward a landmark (i.e., gets close enough, or “points” the apparatus at the landmark). Such an example apparatus can have a direction indication tailored to the desired user experience. For example, it might not have a direction indicating display other than the information displayed, or can indicate directions to nearest stored locations to help the user in finding the next location of interest. The apparatus can use the present location of the apparatus and the present orientation of the apparatus to define an absolute direction of interest, then display to the user information about stored locations that lie within a threshold of that direction of interest. This allows a user to point the apparatus at a landmark, and have the apparatus provide information about the landmark without the user having to physically move to the landmark. The directions of interest can also be stored for later downloading and comparison with other information, allowing the user to point the apparatus at a feature of interest, without physically traveling to the location of the feature, then later access information concerning the feature.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1. A vehicle access device comprising:
a) A secure-vehicle input mechanism;
b) A global positioning system receiver;
c) A static directional sensor;
d) A directional output mechanism, mounted in a known relationship to the directional sensor;
e) A control subsystem, wherein the control subsystem:
i) accesses the global positioning system receiver to determine the present location of the device, and
ii) stores the present location of the device when the secure-vehicle input mechanism is activated, and
iii) determines a direction from the present location to the stored location from the present location, the stored location, and the directional sensor, and
iv) controls the output mechanism to indicate the direction to the stored location.

2. A device as in claim 1, wherein the secure-vehicle input mechanism comprises a push-button switch.

3. A device as in claim 1, wherein the directional output mechanism comprises a display indicating the direction to the stored location.

4. A device as in claim 1, where secure-vehicle input mechanism comprises a pressure sensitive switch, and the directional sensor comprises a compass, and the directional output mechanism comprises a display; and wherein the control system:
a) Determines a direction vector between the present location and the stored location;
b) Determines the present orientation of the display from the compass;
c) Determines a direction relative to the display from the direction vector and the present orientation;
d) Controls the display to indicate the direction relative to the display.

5. A device as in claim 4, wherein
a) the display comprises three indicators, where a first indicator defines a reference axis, and the second and third indicators define second and third axes respectively, the first, second, and third axes being distinct from each other; and
b) wherein the control system determines which of the three axes is a best approximation of the direction relative to the display, and causes the corresponding indicator to enter a state distinguishable from the other two indicators.

6. A device as in claim 5, where the indicators comprise one of (a) three LEDs, and (b) three LCD elements; and wherein causing the indicator to enter a state comprises illuminating the indicator.

7. A device as in claim 4, wherein the display comprises an indicator capable of two different states, where the indicator defines a reference axis; and wherein the control system determines if the reference axis is within an angular threshold of the direction relative to the display, and, if so, then causes the indicator to enter the first state and, if not, causes the indicator to enter the second state.

8. A device as in claim 7, wherein the indicator comprises an LED, and the first state comprises green color illumination, and the second state comprises red color illumination.

9. A device as in claim 4 wherein the display comprises an indicator capable of three states, and wherein the control system causes the indicator to enter a first state when the determined direction is within an angular threshold of a reference axis of the apparatus, to enter a second state when the determined direction is more than the angular threshold to the left of the reference axis, and to enter a third state when the determined direction is more than the angular threshold to the right of the reference axis.

10. A device as in claim 1, further comprising an unlock input responsive to the user which unlock input can initiate a signal to unlock the vehicle.

11. A device as in claim 10, wherein the control system energizes the output mechanism responsive to the unlock input.

12. A device as in claim 11, wherein the control system energizes the output mechanism for a limited time after an activation of the unlock input.

13. A device as in claim 11, wherein the control system determines a distance from the present location to the stored location, and wherein the control system energizes the display and initiates a signal to unlock the vehicle according to the following:
a) If the determined distance is greater than a first value, then the control system energizes the display and does not initiate the unlock signal;
b) If the determined distance is less than the first value, then the control system energizes the display and initiates the unlock signal.

14. A device as in claim 11, wherein the control system determines a distance from the present location to the stored location, and wherein the control system energizes the display and initiates a signal to unlock the vehicle according to the following:
a) If the determined distance is greater than a first value, then the control system energizes the display and does not initiate the unlock signal;
b) If the determined distance is less than the first value, and greater than a second value, then the control system energizes the display and initiates an attention signal;
c) If the determined distance is less than the second value, then the control system energizes the display and initiates the unlock signal.

15. A device as in claim 11, wherein the attention signal comprises one or more of
a) Honking a horn of the vehicle;
b) Energizing one or more lights of the vehicle;
c) Activating a sound source associated with the vehicle.

16. A directional guidance device, comprising:
a) A GPS receiver;
b) A static directional sensor;
c) A directional output system, mounted in a known orientation relative to the directional sensor;
d) An communications system capable of communicating with a store of location information;
e) A control system, wherein the control system:
i) Loads a storage facility from locations communicated to the device via the communications system;
ii) Compares the present location of the device, as indicated by the GPS receiver, with the locations stored in the storage facility to determine which location is in a desired relationship, such as shortest distance or most close to the current heading of the device;
iii) Determines a direction vector from the present location of the device to the determined location;
iv) Determines the present orientation of the display from the directional sensor;
v) Determines a direction relative to the display from the direction vector and the present orientation;
vi) Controls the display to indicate the direction relative to the display.

17. A directional guidance device, comprising:
a) First and second input mechanisms;
b) A GPS receiver;
c) A static directional sensor;
d) A directional output system, mounted in a known orientation relative to the directional sensor;
e) A control system, wherein the control system:
i) Selects one of a plurality of location storage receptacles responsive to the first and second input mechanisms;
ii) Stores the present location of the device, as indicated by the GPS receiver, in the currently-selected location storage receptacle responsive to the first and second input mechanisms;
iii) Determines a direction vector from the present location of the device to the location stored in the currently-selected location storage receptacle;
iv) Determines the present orientation of the display from the directional sensor;
v) Determines a direction relative to the display from the direction vector and the present orientation;
vi) Controls the display to indicate the direction relative to the display.

18. A device as in claim 17, wherein first input mechanism comprises a first switch, and wherein second input mechanism comprises a second switch, and wherein, in the control system:
a) Each location storage receptacle has a defined next-receptacle and a defined previous-receptacle;
b) An input from the first switch and not the second switch causes the selected location storage receptacle to change from the present receptacle to the next-receptacle of the present receptacle;
c) An input from the second switch and not the first switch causes the selected location storage receptacle to change from the present receptacle to the previous-receptacle of the present receptacle;
d) An input from both the first switch and the second switch causes the present location of the device to be stored in the present receptacle.

19. A device as in claim 17, wherein the output system further comprises a distance output mechanism, and wherein control system further determines a distance from the present location of the device to the location stored in the currently-selected receptacle, and causes the distance output mechanism to output an indication of the distance.

20. A device as in claim 19, wherein
a) the display comprises three indicators, where a first indicator defines a reference axis, and the second and third indicators define second and third axes respectively, the first, second, and third axes being distinct from each other; and
b) Wherein the control system determines which of the three axes is a best approximation of the direction relative to the display, and causes the corresponding indicator to enter a state distinguishable from the other two indicators.
